(19) United States
(12) Patent Application Publication
(10) Pub. No.: US 2003/0200646 A1
(43) Pub. Date: Oct. 30, 2003

(54) Manufacturing method for a spindle motor rotor hub

(76) Inventors: Rikuro Obara, Kitasaku-Gun (JP); Akimasa Suzuki, Nagano-Ken (JP)

Correspondence Address: SCHULTE ROTH & ZABEL LLP, ATTN: JOEL E. LUTZKER, 919 THIRD AVENUE, NEW YORK, NY, 10022, US

(21) Appl. No.: 10/397,771

(22) Filed: Mar. 26, 2003

(30) Foreign Application Priority Data
Mar. 28, 2002 (JP) 2002-091122

(51) Int. Cl. H02K 15/02; B23B 11/00

(52) U.S. Cl. 29/598; 29/596; 29/34 R

(57) ABSTRACT

The method for manufacturing a spindle motor rotor hub of the present invention where a disk-shaped bulk is shaped by cutting a specified thickness of a round bar material, such as metal, perpendicular to the axial line thereof. This disk-shaped bulk is then cold forged and formed into a machining workpiece, which has approximately the shape of the rotor hub. The two ends of the machining workpiece are ground to form parallel upper and lower machining reference surfaces. The peripheral surface of the machining workpiece is then ground to form a peripheral machining reference surface. Finishing is accomplished by cutting and grinding each part of the rotor hub based on the aforementioned upper and lower machining reference surfaces and on the peripheral machining reference surface.

### BACKGROUND OF THE INVENTION

1. Field of the Invention

The present invention relates to a manufacturing method for a rotor hub that serves as a rotating part in a spindle motor. In particular, it relates to a manufacturing method for a rotor hub configured to be used with a spindle motor used to drive a magnetic disk in a hard disk drive device.

2. Description of the Related Art

Previously, rotor hubs forming the rotating part of spindle motors in office automation equipment such as hard disk drives were manufactured by first fabricating a workpiece formed of a disk-shaped blank made by annular cutting of a round bar material having a diameter somewhat larger than the outer diameter of the hub. This disk-shaped workpiece was then machine cut and manufactured to a desired shape and dimension.

Another method of manufacturing rotor hubs also exists, whereby a workpiece is cast. The dimension of the workpiece includes the desired cutting stock added to the shape of the rotor hub to be manufactured. This cast workpiece is then machine cut and manufactured to a desired shape and dimension.

However, in a contemporary hard disk drive device it has become necessary to rotate the magnetic disk with greater accuracy as data recording density to the magnetic disk has increased. This has required the use, for example, of a sliding fluid bearing for the bearing device supporting the rotor hub for rotation. This, in turn, makes it necessary to perform very high precision machining of rotor hubs used to mount magnetic disks.

Specifically, it is necessary to perform high precision machining for both the rotor hub concentric accuracy, which affects vibration in the magnetic disk radial direction, and flatness on the magnetic disk mounting surface, which is a cause of very fine waviness in the magnetic disk.

It is necessary that a machining reference surface and reference point be accurately established on the workpiece for high accuracy machining of rotor hubs, but as mentioned above, the surfaces of disk-shaped workpieces or cast workpieces are not very accurate planar or curved surfaces. Therefore, it is difficult to establish an accurate reference surface or reference point on the work surface for machining. It has therefore not been possible to implement higher accuracy rotor hub machining.

There is also a great deal of material waste due to the large amount of cuttings generated with the aforementioned machining methods based on disk-shaped work, leading to the problem of increased manufacturing cost.

While the problem of cuttings which occur in the above-described disk-shaped workpiece is eliminated in the case of the aforementioned cast workpiece-based machining method, but setting the stock allowance so as not to leave a casting cavity on the surface during casting is difficult. Moreover, tiny casting cavities remain, that can cause cutting oil or cleaning fluid to enter the casting cavity, causing outgassing.

There is therefore a danger that when a cast workpiece-based rotor hub is used to drive a magnetic disk in a hard disk drive device, the above-described outgas emanating from the rotor hub could condense on the magnetic disk surface and adhere thereto. As such condensate rotates with the fast-rotating magnetic disk, it can run into the magnetic head and cause a disk crash, reducing hard disk drive reliability.

### SUMMARY OF THE INVENTION

The object of the present invention is to provide a rotor hub on which a machining reference surface for cutting and grinding can be accurately established such that the rotor hub can be machined with extremely high accuracy, which results in few cuttings such that material yield is favorable, and which is free of the danger of hard disk drive faults resulting from casting cavities which occurred in conventional cast workpieces.

In order to achieve the above-described objectives, the method for manufacturing a spindle motor rotor hub of the present invention is provided such that a disk-shaped bulk is shaped by cutting a specified thickness of a round bar material, such as metal, perpendicular to the axial line thereof. This disk-shaped bulk is then cold forged and formed into a machining workpiece, which has approximately the shape of the rotor hub. The two ends of the machining workpiece are ground to form parallel upper and lower machining reference surfaces. The peripheral surface of the machining workpiece is then ground to form a peripheral machining reference surface. Finishing is accomplished by cutting and grinding each part of the rotor hub based on the aforementioned upper and lower machining reference surfaces and on the peripheral machining reference surface.

Also, the upper and lower machining reference surfaces of the aforementioned workpiece are simultaneously formed by grinding with two rotating grindstones such that ground surfaces of the two cut end surfaces of the machining workpiece are parallel.

### BRIEF DESCRIPTION OF DRAWINGS

A full understanding of the invention can be gained from the following description of the preferred embodiments when read in conjunction with the accompanying drawings in which:

FIG. 1 is a vertical sectional perspective view depicting an embodiment of the stages of the manufacturing method according to the present invention;

FIG. 2 is a vertical section depicting a specific example of the forging stage;

FIG. 3 is a vertical section depicting the relationship between the workpiece and the upper and lower machining reference surfaces following the forging stage;

FIG. 4 is a front view depicting a concrete example of a planar grinding device;

FIG. 5 is a partial sectional plane view of a planar grinding device;

FIG. 6 is a vertical section depicting the relationship between the workpiece, and the peripheral machining reference surface after upper and lower surface grinding;

FIG. 7 is a partial vertical front section depicting a concrete example of a peripheral surface grinding device;

FIG. 8 is a top view of a peripheral surface grinding device;

FIG. 9 is a top view depicting another example of a peripheral surface grinding device;

FIG. 10 is a plane view depicting yet another example of a peripheral surface grinding device;

FIG. 11 is a vertical section along lines XI-XI of FIG. 10;

FIG. 12 is a vertical section along lines XII-XII of FIG. 10;

FIG. 13 is a vertical section along lines XIII-XIII of FIG. 10;

FIG. 14 is a vertical section depicting a rotor hub after finish machining; and

FIG. 15 is a vertical section depicting an example of the rotor hub in use.

### DETAILED DESCRIPTION OF THE PREFERRED EMBODIMENT

An embodiment of the rotor hub manufacturing method in accordance with the present invention is explained below based on specific examples depicted in the attached drawings.

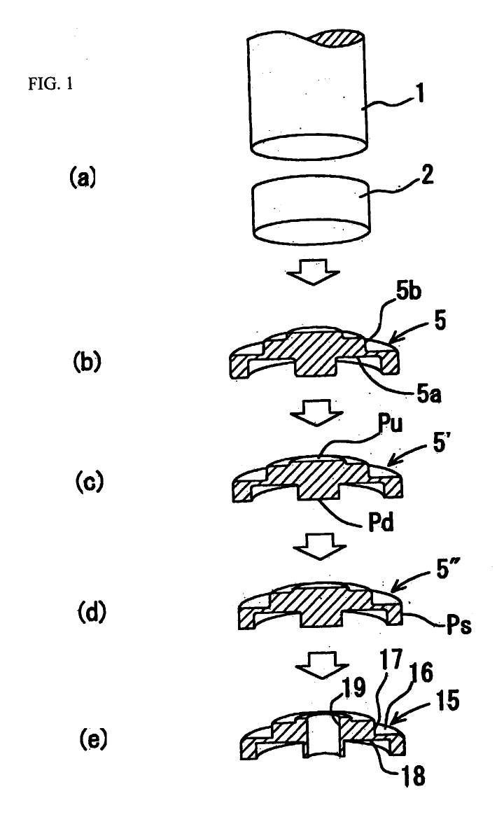

First, metal round bar 1 serving as the rotor hub material is cut with a cutter in a direction perpendicular to the axis of the round bar material, forming disk-shaped bulk 2 as shown in FIG. 1(a). Stainless steel may be used as the material for the round rod.

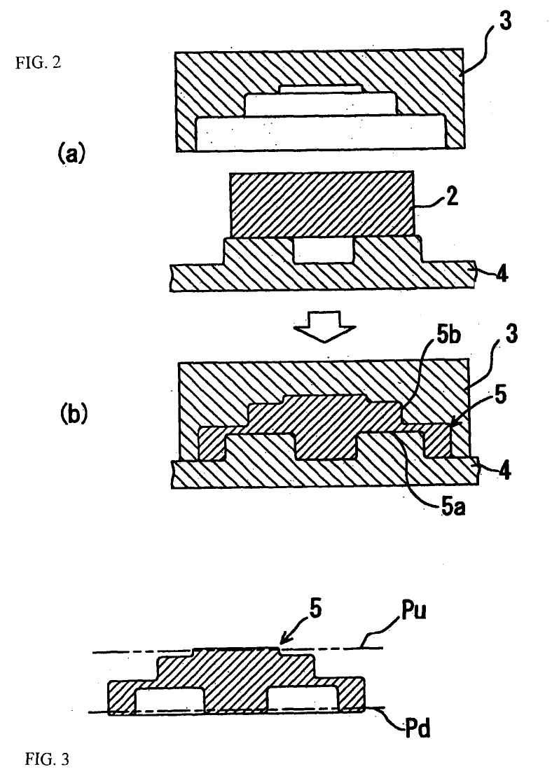

Next, bulk 2 is cold forged by means of upper forging mold 3 and lower forging mold 4 used for forging as depicted in FIG. 2(a). Workpiece 5 having approximately the shape of the rotor hub is obtained as a result of the cold-forging process, as shown in FIGS. 1(b) and 2(b).

Peripheral channel 5a corresponding to a stator receiving part is formed on the lower side of workpiece 5 in the above-description forging stage. A small diameter portion 5b corresponding to a disk mounting portion is formed on the upper side of the workpiece.

Next, the two cut end surfaces of workpiece 5 are ground. A specified workpiece height is established by this grinding stage, while at the same time the upper and lower machining reference surfaces Pu and Pd are formed parallel to each other, as shown by the imaginary lines in FIG. 3. As a result, a workpiece 5′ having parallel upper and lower surfaces, Pu and Pd, respectively, is obtained, as shown in FIG. 1(c).

These upper and lower machining reference surfaces will become the upper and lower direction reference surfaces at the cutting and grinding stages of the finish machining described below.

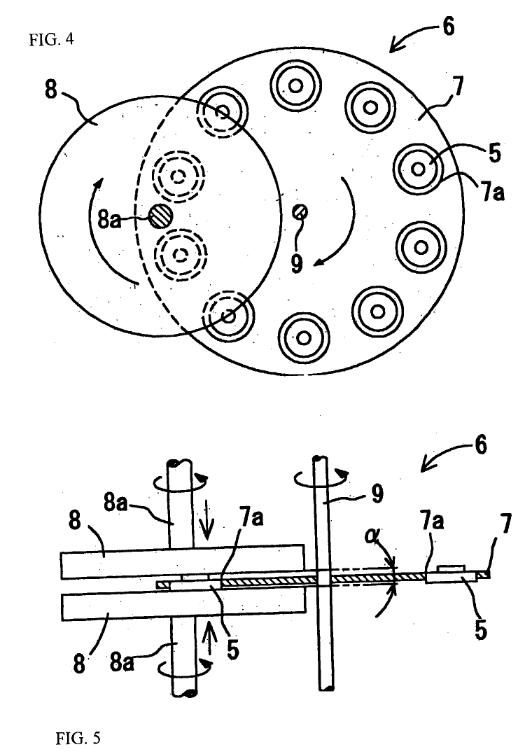

Planar grinding device 6 as shown in FIGS. 4 and 5, for example, may be used in the above-described grinding stage for grinding the two end surfaces.

The aforementioned planar grinding device 6 comprises a disk-shaped workpiece holder 7 having holder holes 7a, for holding workpieces 5. Grinding device 6 further includes two disk-shaped rotating grindstones 8, the grinding surfaces of which face and are parallel to one another and parallel to the workpiece holder plate. The grinding surfaces are respectively caused to rotate at high speed in the same direction as the turning of the rotating axis 8a.

More specifically, each work holder 7a of the work holder plate 7 is arrayed peripherally as shown, for example, in FIG. 5. Each work holder 7a holds machining workpiece 5 peripheral surface around the axis. As shaft 9 is slowly rotated, the workpiece is sequentially fed between the aforementioned rotating grindstones.

The grinding surfaces of rotating grindstones 8 are substantially parallel, but taking into account the incursion into the workpiece, they are preferably opened by a small angle α with respect to the work holder shaft 9.

When grinding the two cut end surfaces, machining workpieces 5 are respectively held in each holder hole 7a of work holder plate 7. Left and right rotating grindstones 8 are moved so as to approach one another and are brought into the contact with the two cut end surfaces of the workpiece. By rotating the work holder plate at low speed while the rotating grindstones are rotated at high speed, the workpiece is fed in between the rotating grindstone grinding surfaces.

The two rotating grindstones are then gradually moved so as to approach one another, gradually narrowing the gap between the grinding surfaces and continuously workpiece surfaces grinding until the height of the workpiece reaches a specified value.

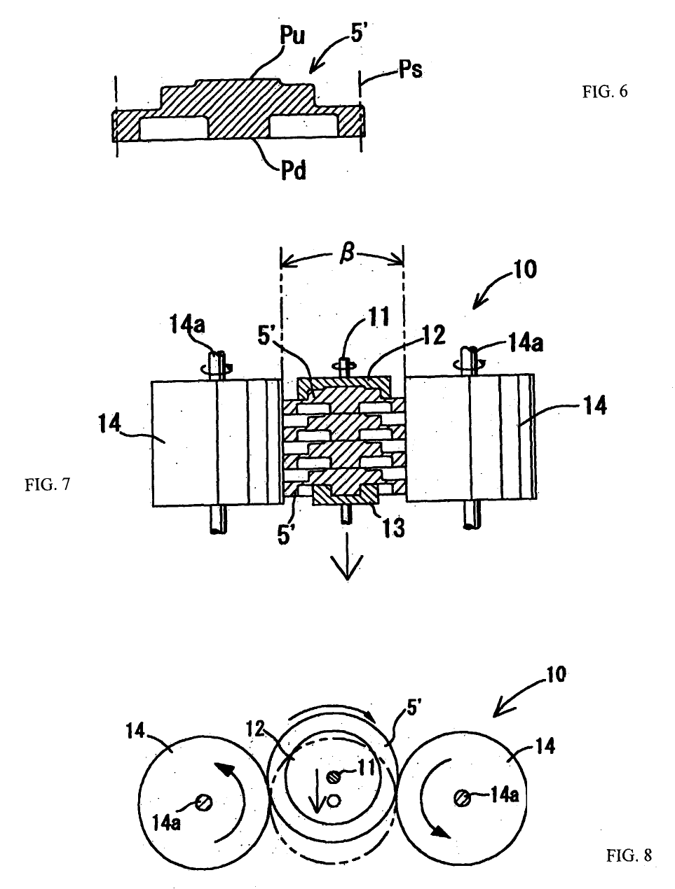

Next, the peripheral surface of machining workpiece 5′ is ground. The peripheral grinding stage sets the workpiece diameter to a fixed value, at the same time forming a peripheral machining reference surface Ps as shown by the imaginary lines in FIG. 6. As a result of this stage a machining workpiece 5″ with accurately formed upper, lower, and peripheral surfaces is obtained, as shown in FIG. 1(d).

The aforementioned peripheral machining reference surface Ps becomes the radial reference surface for cutting and grinding of the finish machining described below.

The peripheral grinding device 10 shown in FIGS. 7 and 8 is used in the above-described peripheral surface grinding stage.

The aforementioned peripheral grinding device 10 comprises upper and lower crimping parts 12 and 13, respectively, which crimp multiple workpieces 5′ such that they stack vertically in the axial direction and are capable of rotation around axis 11 cylindrical grindstones 14 having rotating axles 14a parallel to the aforementioned crimping piece shaft 11 are located to the left and right of these crimped workpieces. A very small taper angle β is imparted between the peripheral surfaces (grinding surfaces) of the left and right cylindrical grindstones. The grinding surface gap between the left and right cylindrical grindstone is set at the top to be virtually equal to the diameter of the machining workpiece 5′ before grinding, and at the bottom to be equal to the outer diameter of the finished workpiece.

When grinding the peripheral surface, workpieces 5′ are first stacked and crimped between the aforementioned upper and lower crimping parts 12 and 13 so as to prevent displacement of the workpiece during grinding. At this point, the surfaces which will become the top and bottom of the workpiece are formed to be parallel in the two cut end surface grinding stage. Therefore, the workpieces are stacked in such a way that each workpiece contacts the machining reference surface of the workpieces above and below it. Thus, the workpieces are set in parallel.

Left and right cylindrical grindstones 14 are caused to rotate at high speed around their corresponding rotating shafts 14a. The workpiece is gradually moved toward the area between the grindstones along with crimping pieces 12 and 13. The grinding surfaces of cylindrical grindstones 14 are brought in contact with the peripheral surface of each workpiece causing the workpiece to rotate, along with crimping parts 12 and 13, and thus grinding the peripheral surface with the grinding surface.

Crimping part 12 or 13 is gradually advanced in a parallel motion toward the center between cylindrical grindstones 14 and polishing continues until the diameter of the workpiece peripheral surface becomes the same as the gap between the grinding surfaces of two cylindrical grindstones 14. Thereafter, the workpiece is moved downward in the axial direction, and grinding is completed by passing the workpiece through the lower portion between grindstones 14, where the gap between grindstone grinding surfaces is minimal and equal to the predetermined finished outer diameter dimension of the workpiece.

As explained above, grinding the peripheral surface enables grinding of multiple workpieces at once while also offering ease and stable accuracy of the grinding process.

When setting workpieces 5′ on the aforementioned upper and lower crimping parts 12 and 13, it is preferable to place the center of workpiece 5′ as accurately as possible. However, even if there is some offset in the workpiece center, the peripheral surface ground in the peripheral stage described above will become the radial machining surface in the finish machining cutting and grinding stage described below. Therefore, there is no danger that this offset will affect the final product rotor hub dimensional accuracy.

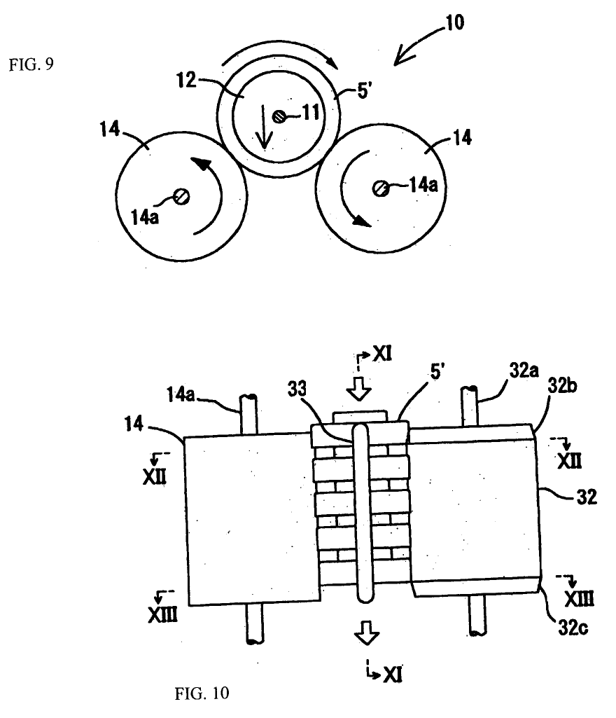

The peripheral grinding device 10 described above adopts a configuration in which the gap between the grinding surfaces of left and right cylindrical grindstones 14 is set to be essentially the same as the workpiece's finished outer diameter dimension. However, as shown in FIG. 9, cylindrical grindstones 14 are arrayed such that the gap between left and right cylindrical grindstones 14 may become narrower than the finished diameter of the workpiece. By means of crimping parts 12 and 13, workpieces 5′ are gradually moved toward the space between cylindrical grindstones 14 so as to implement grinding. Thus, there are cases in which the workpieces outer diameter is determined according to the distance the workpiece is caused to move between the grindstones.

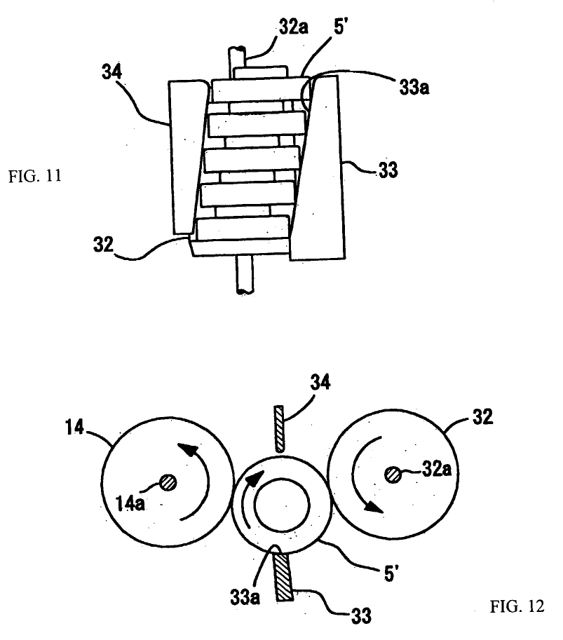

In cases in which the workpiece's peripheral surface axial direction dimension (height) is large and there is no danger of the workpiece tilting even if it is not held in place at the top and bottom, crimping parts 12 and 13 might not be used. In such cases, as shown for example in FIGS. 10-12, a peripheral surface grinding device preferably comprises cylindrical grindstone 14, driven by the rotation of shaft 14a, free roller 32, which can be freely rotated around shaft 32a, and guide rail 33 for workpiece 5′. The cylindrical grindstone and the free roller are arrayed to the left and right of the workpiece such that shafts 14a and 32a are parallel. Guide rail 33 is placed on the near side of the workpiece between the grindstone and the free roller.

In the abovementioned guide rail 33, the rear edge contacting the workpiece has an inclined surface 33a, which is inclined backward and downward towards the workpiece center. As the workpiece moves downward, the guiderail is caused to move backward.

Within the horizontal surface, the workpiece is supported by its three contact points with the aforementioned grindstone, the free roller peripheral surface, and the inclined surface of the guide rail. The inclined surface of the guide rail, however, tilts backward towards the bottom, such that a circle is defined by the aforementioned three contact points. The diameter of this supporting circle becomes gradually smaller in the downward direction, and, therefore, as the workpiece diameter becomes gradually smaller with the advance of grinding, the workpiece moves downward.

Dropout prevention pieces 34 are arrayed on the far side of the gap between the aforementioned grindstone and the free roller. Dropout prevention pieces 34 face one another between guide rail 33 and the workpiece. They are preferably arrayed such that their front edge is positioned slightly behind the above-described circle defined by the contact points of the grindstone, free roller peripheral surface and guide roller inclined surface. During normal grinding, the workpiece would not contact a dropout prevention piece, but if for some reason the workpiece were to jump back from the space between the grindstone and the free roller, the workpiece would contact that dropout prevention piece and be returned to a specified position, such that it would not drop out of the grinding machine.

Tapered surfaces 32b and 32c having smaller diameters toward the top and bottom are respectively provided on the upper and lower portion of free roller 32 peripheral surface, making it easy to supply and remove the workpiece to and from the grinding machine.

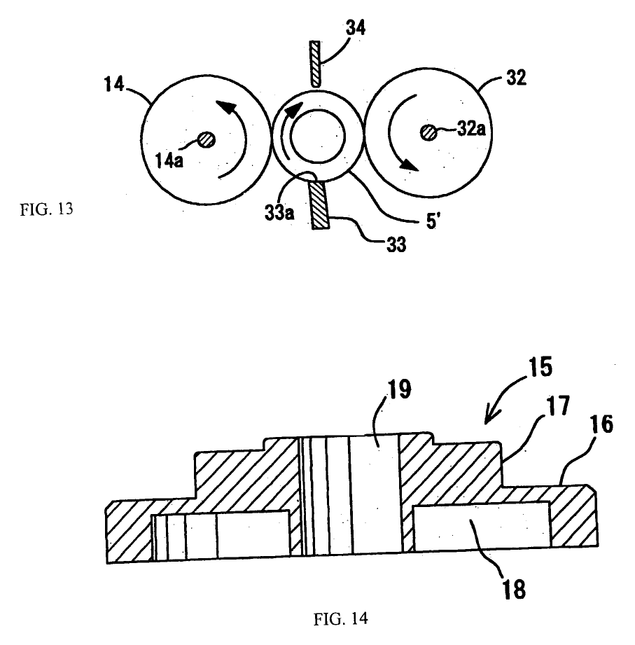

In a grinding machine constituted as described above, the distance between cylindrical grindstone 14 and the peripheral surface of free roller 32 is set so as to be equal to the workpiece finished diameter. When grindstone shaft 14a is driven and workpiece 5′ is fed between the grindstone, the free roller and guide rail, the workpiece, as shown in FIG. 12, internally contacts and is supported by cylindrical grindstone 14, free roller 32 peripheral surface, and guide rail inclined surface 33a. The workpiece and the free roller rotate with the rotation of the grindstone. The peripheral surface of the workpiece is ground by contact with the grindstone peripheral surface, its outer diameter gradually decreasing as it moves lower.

When the workpiece moves to the lowest position and the workpiece diameter is equal to the distance between the grindstone peripheral surface and the free roller peripheral surface, that is to say when the workpiece outer diameter equals the finish dimensions, the workpiece is ejected downward and grinding is completed.

In the above-described peripheral grinding device, there is no need to set the workpiece between the crimping parts, thereby offering the advantage that multiple workpieces can be continuously polished by sequentially feeding the workpiece from above into the area between free roller 32 and guide rail 33.

Next, as shown in FIG. 1(d) finish machining of workpiece 5″ is carried out using standard cutting and grinding. As shown, for example, in FIG. 14, precise shaping of various parts of rotor hub 15, such as disk mounting surface 16, disk fitting surface 17, stator holding section 18, and center vertical hole 19, is performed.

In the above-described finish machining, as shown in FIG. 6, cutting and grinding are performed with reference to upper and lower machining reference surfaces Pu and Pd formed by the previously mentioned grinding of the two cut end surfaces, and with reference to the peripheral reference surface Ps, formed by peripheral surface grinding.

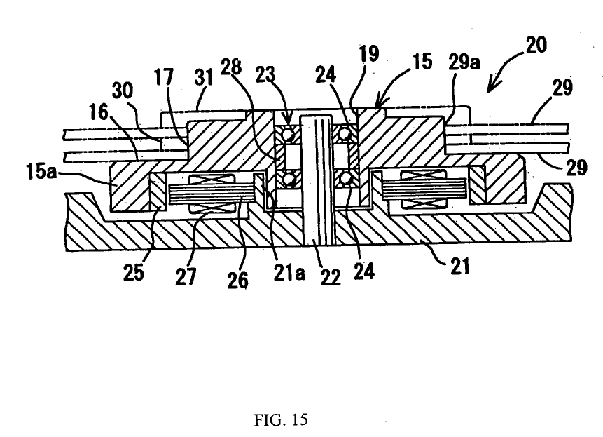

Rotor hub 15 manufactured by the method of the present invention described above and shown in FIG. 15 is assembled into spindle motor 20 in, for example, a hard disk drive device.

Specifically, rotor hub 15 is affixed through motor base 23 to spindle 22 which is vertically mounted in motor base 21. Motor base 23 comprises upper and lower ball bearings 24. Rotor hub center vertical hole 19 is fit around these bearings, and the rotor hub is supported so as to be capable of rotating around spindle 22.

Rotor magnet 25 is provided on the inside surface of peripheral downward pointing flange 15a of the above rotor hub 15. Stator 26 radially facing the inner surface of this rotor magnet is affixed to holder section 21a formed on motor base 21.

Supply of a drive current to electrically conductive coil 27 wound around stator 26 causes rotational drive force to be generated in a rotor magnet such that the rotor hub is driven to rotate in the above-described center vertical hole 19. Reference numeral 28 in the same diagram indicates the space between ball bearings 24 in motor base 23.

In center vertical hole 19 as described above, one or multiple (2 in FIG. 15) magnetic disks 29 are mounted as shown, for example, by the imaginary lines in FIG. 15, and the magnetic disk is caused to rotate with the rotor hub rotational drive.

The above magnetic disk 29 is attached by fitting center hole 29a thereof onto rotor hub's 15 disk fitting surface 17. The underside of the lower magnetic disk is supported by disk mounting surface 16. Magnetic disk spacer 30 is inserted between the magnetic disks. The top surface of the upper magnetic disk is held down by hold down plate 31 affixed at an appropriate place on rotor hub 15 by means of a screw or other affixing piece (not shown.).

In the embodiment described above, a metal such as stainless steel is used for round bar 1 which is used to manufacture the rotor hub. There are also cases in which ceramic or synthetic resin can be used as the material of the round bar 1.

Also, in the specific motor example described above, center vertical hole 19 disposed through the hub contains upper and lower ball bearings 24 of motor base 23. However, there are also cases in which a higher rotational accuracy device such as a sliding fluid hub, etc., would be used for motor base 23.

According to the method of the present invention, upper and lower machining reference surface, are formed on the cut end surfaces of the workpiece to be machined, and a peripheral machining reference surface is formed on the peripheral surface of the workpiece to be machined. The shapes of the various rotor hub parts are formed by cutting and grinding with reference to these machining reference surfaces. Therefore, cutting and grinding can be accurately effected, making it possible to manufacture rotor hubs of high accuracy.

Also, according to the method of the present invention a round bar material is cut to form disk-shaped bulks. Machining workpieces having the approximate shape of the rotor hub are formed by cold forging these disk-shaped bulks, so there is no problem of large quantities of cuttings and resultant decrease in material efficiency as occurs with conventional direct cutting of blank material, nor is there the danger of negative effects on the motor-assembled devices caused by casting cavities which occur when the machining workpiece is formed by casting. As such, it is possible to realize a rotor hub with favorable material yield and without a reduction in the reliability of motor-assembled devices such as hard disk drives.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

We claim:

1. A method for manufacturing a rotor hub comprising the steps of:
obtaining a disk of specified thickness;
cold forging said disk into a workpiece having a plurality of surfaces including a top surface, a bottom surface, and a peripheral surface;
grinding said top surface to form a top machining reference surface and grinding said bottom surface to form a bottom machining reference surface such that said machining reference surfaces are parallel;
grinding said peripheral surface of the workpiece to form a peripheral machining reference surface; and
using said top, bottom, and peripheral machining reference surfaces to cut and to grind the workpiece into a rotor hub.

2. The method for manufacturing a rotor hub according to claim 1, wherein said step of obtaining said disk of specified thickness further comprises:
obtaining a cylindrical rod of material; and
cutting said rod perpendicular to its axis into said disk of specified thickness.

3. The method for manufacturing a rotor hub according to claim 1, wherein the steps of grinding said top surface and said bottom surface further comprises:
simultaneously using two parallel rotating grindstones to shape the top surface and the bottom surface of said workpiece.

4. The method for manufacturing a rotor hub according to claim 1, wherein the step of cold forging further comprises using an upper forging mold and a lower forging mold.

5. The method for manufacturing a rotor hub according to claim 1 further comprising:
installing the rotor hub into a spindle motor.

6. The method for manufacturing a rotor hub according to claim 5 further comprising:
installing the spindle motor into a hard disk drive device.

7. The method for manufacturing a rotor hub according to claim 2, wherein the rod of material is made of stainless steel.

8. The method for manufacturing a rotor hub according to claim 2, wherein the rod of material is made of ceramic.

9. The method for manufacturing a rotor hub according to claim 2, wherein the rod of material is made of synthetic resin.
